(19) United States
(12) Patent Application Publication
(10) Pub. No.: US 2022/0042494 A1
(43) Pub. Date: Feb. 10, 2022

(54) LOW-COST CARBON FIBER-BASED LIGHTNING STRIKE PROTECTION

(71) Applicant: UT-Battelle, LLC, Oak Ridge, TN (US)

(72) Inventors: Vipin Kumar, Oak Ridge, TN (US); Vlastimil Kunc, Oak Ridge, TN (US); Merlin Theodore, Oak Ridge, TN (US)

(21) Appl. No.: 17/398,063

(22) Filed: Aug. 10, 2021

Related U.S. Application Data
(60) Provisional application No. 63/063,515, filed on Aug. 10, 2020.

(51) Int. Cl. F03D 80/30; B29C 70/20; B29C 70/30

(52) U.S. Cl. CPC F03D 80/30; B29K 2063/00; B29C 70/30; B29C 70/205

(57) ABSTRACT

A method of manufacturing a wind turbine blade with integrated lightning strike protection is provided. The method includes forming a plurality of fiber reinforced plies having carbonized textile-grade PAN fibers. The fiber reinforced plies are then stacked on a surface of a mold, wetted with a resin, and cured to form at least part of a wind turbine blade. Because the textile-grade PAN fibers are electrically conductive, the resultant structure provides both electrical conductivity and structural integrity. Laboratory testing of carbon fiber structures against simulated lightning strikes demonstrated high resilience due to their high electrical conductivity both in-plane and in through-thickness directions, with no significant damages, e.g., fiber breakage, resin evaporation, or delamination. High-temperature epoxy helped to improve the performance of the CFRP against the lightning strikes.

### CROSS-REFERENCE TO RELATED APPLICATIONS

This application claims the benefit of U.S. Provisional Application 63/063,515, filed Aug. 10, 2020, the disclosure of which is incorporated by reference in its entirety.

### STATEMENT REGARDING FEDERALLY SPONSORED RESEARCH AND DEVELOPMENT

This invention was made with government support under Contract No. DE-AC05-00OR22725 awarded by the U.S. Department of Energy. The government has certain rights in the invention.

### FIELD OF THE INVENTION

The present invention relates to a method of manufacturing wind turbine blades, aircraft structures, UAV/UAM, missiles, radomes, and fuel tanks with integrated lightning strike protection.

### BACKGROUND OF THE INVENTION

Wind turbine blades, aircraft structures, UAV/UAM, missiles, radomes, and fuel tanks are typically manufactured from layers of fiber reinforced plies that are arranged on a molding surface and subjected to vacuum and heat to cause softening of a resin, which is then allowed to cure. Carbon fiber composites are becoming the prominent material for load bearing lightweight structures. For example, until recently, glass fiber reinforced plastic (GFRP) was the preferred choice for wind turbine blades. However, to harvest the maximum amount of wind energy, ever larger wind turbine blades are being manufactured. To support such large structures, carbon fiber reinforced plastic (CFRP) has become an integral part of the load bearing structure for wind turbine blades.

However, lightning strike protection of wind turbine blades is one of the biggest challenges in the incorporation of CFRP structures in wind turbines. Due to the very low electrical conductivity of CFRP structures as compared to their metal counterpart structures, they perform poorly when struck by lightning. Engineers have used a range of protective methods, including current arrestors, down conductors, or coatings to render CFRP structures safe against lightning strikes. Copper (Cu), aluminum (Al), and nickel (Ni) films are typical forms of lightning strike protection. However, there remains a continued need for an improved method for manufacturing wind turbine blades that are lightweight and yet resistant to lightning strikes.

### SUMMARY OF THE INVENTION

A method of manufacturing a wind turbine blade with integrated lightning strike protection is provided. The method includes forming a plurality of fiber reinforced plies having highly carbonized conductive polymer fibers, for example carbonized textile-grade polyacrylonitrile (PAN) fibers. The fiber reinforced plies are then stacked on a surface of a mold, wetted with a resin, and cured to form at least part of a wind turbine blade. Because the carbonized textile-grade PAN fibers are highly electrically conductive, the resultant structure provides both electrical conductivity and structural integrity. Laboratory testing of carbon fiber structures against simulated lightning strikes demonstrated high resilience due to their high electrical conductivity both in-plane and in through-thickness directions, with no significant damages, e.g., fiber breakage, resin evaporation, or delamination.

These and other features of the invention will be more fully understood and appreciated by reference to the description of the embodiments and the drawings.

### BRIEF DESCRIPTION OF THE DRAWINGS

FIG. 1 is a schematic view of a mold for manufacturing a wind turbine blade section in accordance with an embodiment of the present invention.

FIG. 2 is a perspective view of a wind turbine blade and cross-section when formed in accordance with the method of the present invention.

FIG. 3 is a circuit diagram for a simulated lightning strike test including a test sample positioned over a discharge electrode.

FIG. 4 is a table illustrating the thickness, carbon fiber (CF) volume fraction, and electrical conductivity of composite panels according to a laboratory example.

FIG. 5 is a table illustrating the flexural mechanical properties of composite panels after a lightning strike test according to a laboratory example.

### DETAILED DESCRIPTION OF THE CURRENT EMBODIMENTS

The current embodiments include a method of manufacturing a section of a wind turbine blade or other article. The method generally includes: (a) providing a plurality of fiber-reinforced plies each including a plurality of electrically conductive carbon fibers, (b) laying up the fiber-reinforced plies onto a surface of a mold, (c) wetting each of the fiber-reinforced plies with a resin, and (d) curing the resin to form at least a section of a finished article, such that the plurality of electrically conductive carbon fibers provides structural integrity to the finished article. Each operation is separately discussed below. Though primarily described below in connection with a wind turbine blade, the present method of manufacturing is also well suited for the manufacture of aircraft structures, UAV/UAM, missiles, radomes, fuel tanks, and other articles.

Providing a plurality of fiber-reinforced plies includes preparing electrically conductive carbon fibers. The electrically conductive carbon fibers can include, for example, carbonized textile-grade PAN fibers, carbon fibers coated with a textile-grade PAN film, or carbon nanotubes that are coated with a textile-grade PAN film. In embodiments that include carbonized textile-grade PAN fibers, the fibers can be formed from a textile-grade PAN precursor via solution spinning, wet-spinning, or melt-spinning. The fibers are then stabilized, oxidized, and carbonized. Carbonization can include heating to between 300° C. to 1800° C. in an inert atmosphere while under tension, yielding fibers with a carbon content of between 80-95%. In embodiments that include carbon fibers coated with a textile-grade PAN film, carbon fibers are soaked in a textile-grade PAN solution, allowed to dry, and subsequently carbonized. In embodiments that include carbon nanotubes coated with a textile-grade PAN film, the carbon nanotubes are soaked with a textile-grade PAN film, allowed to dry, and subsequently carbonized. Other embodiments include PAN fibers with a polyaniline coating or a graphene coating.

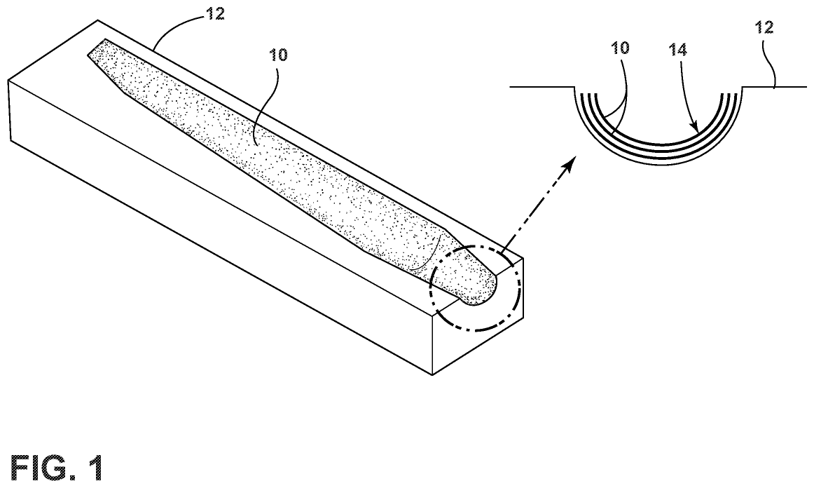

Laying up the plurality of fiber-reinforced plies includes stacking the fiber-reinforced plies 10 on a shaping die 12, generally shown in FIG. 1. The fiber-reinforced plies can include unidirectional fibers, biaxial fibers, or triaxial fibers. For example, the fiber-reinforced plies can include biaxial fibers oriented at ±45 degrees relative to the longitudinal axis of the shaping die 12. The resulting lay-up is then covered with a vacuum bag. The mold cavity that is formed between the vacuum bag and the shaping die 12 is then evacuated. Resin in a liquid form is injected into the vacuum bag while under suction, and the resin impregnates the fiber-reinforced plies. Heat and/or pressure can be applied to the layup, followed by a curing of the resin. Once the resin becomes hardened, the vacuum bag is removed, thereby obtaining a section of the wind turbine blade.

In other embodiments, the plies 10 can be wetted with a resin prior to placement in the shaping die 12. Further optionally, a pre-form 14 is used. The pre-form can include a plurality of pre-impregnated fiber-reinforced plies each including a plurality of electrically conductive fibers within a resin matrix, wherein the plurality of electrically conductive fibers include carbonized textile-grade PAN fibers, carbon fibers that are coated with a textile-grade PAN film, or carbon nanotubes that are coated with a textile-grade PAN film.

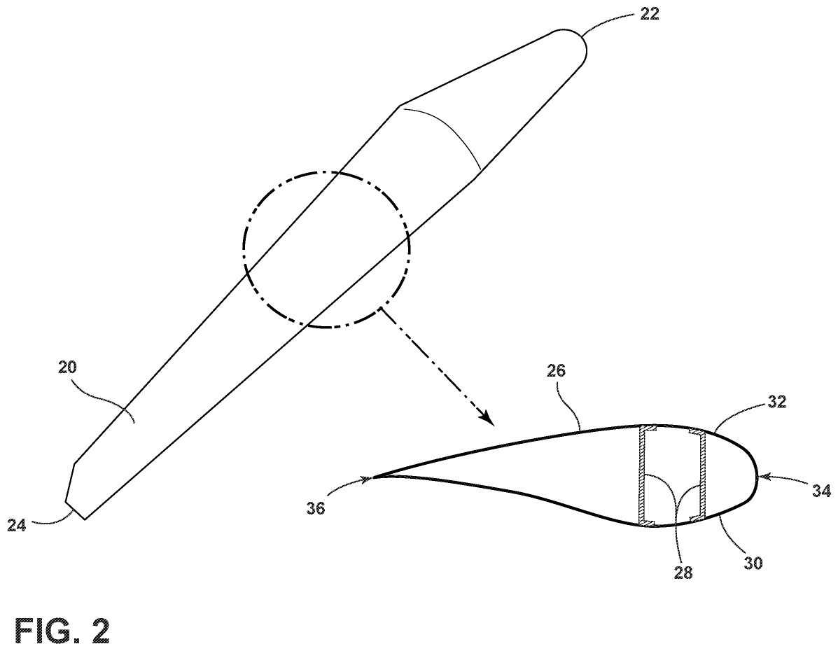

As shown in FIG. 2, the resultant article can comprise all or a portion of the outer shell of a wind turbine blade 20. The wind turbine blade 20 extends from a blade root 22 to a blade tip 24 and includes an outer shell 26 and first and second spars 28. The outer shell 26 includes a pressure-side section 30 and a suction-side section 32, with each section comprising a plurality of electrically conductive carbon fibers within a cured resin matrix. The pressure-side section 30 and the suction-side section 32 can be glued together along the leading edge 34 and the trailing edge 36 of the wind turbine blade 20. The spars 28 are disposed inside the outer shell 26 and extend in the longitudinal direction of the wind turbine blade 20. Because the textile-grade PAN fibers are electrically conductive, the finished structure provides both electrical conductivity and structural integrity.

The present invention is further described below in connection with a laboratory example, which is intended to be non-limiting.

Carbon fiber reinforced composites were fabricated using a hand lay-up method followed by compression molding. Epon 862 resin and an Epikure curing agent were used to impregnate the carbonized textile-grade PAN fibers. A continuous fiber tow was spread and taped to produce 76 mm by 102 mm wide sheets. Sixteen sheets were layered at 0/90°, and the epoxy resin with a resin-to-curing agent ratio of 3:1 was poured and spread on each layer. A perforated release film was placed on top of the fabric lay-up, and the entire setup was sealed with a bagging material. An aluminum caul plate was positioned on the sealed setup to achieve a good surface finish. The resulting assembly was placed in a compression molding press (Carver Model 3895 Hot Press) at 180° C. and 0.6 MPa for 60 minutes. The resultant panel was then trimmed to 200 mm×200 mm for lightning strike testing. A reference panel was prepared with eight layers of pre-preg (F634B-05P), which included T300-3K plain woven fabric and #2500 epoxy from Toray Industries.

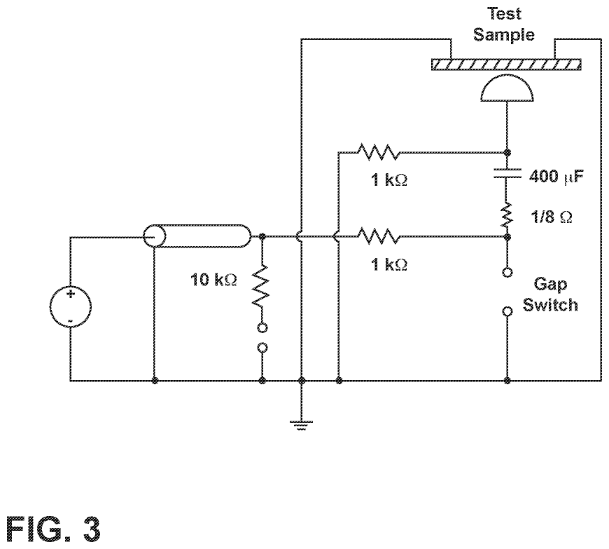

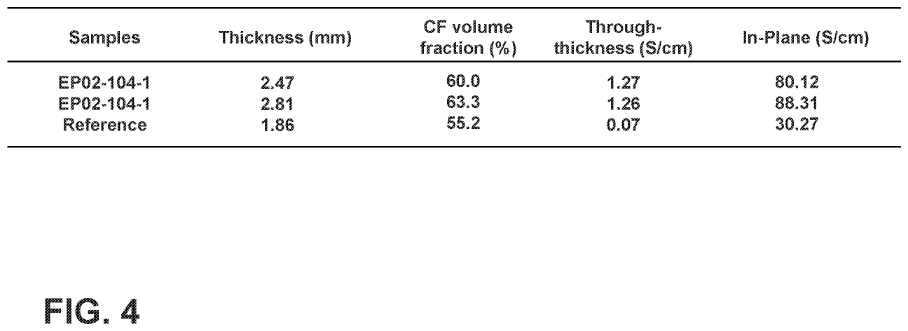

An impulse current generator was used to simulate lightning strike tests on two test panels and the reference panel. Each panel was grounded to a steel plate with copper strips, steel strips, and braided wires. The panels were placed face down on top of the impulse current generator's discharge electrode, shown in FIG. 3, and struck by a simulated lightning strike with current discharges of 93.6 kA and 197.6 kA (component A of lightning waveform SAE ARP 5412-B). The electrical conductivity of the test panels and the reference panel was measured in the through-thickness direction and the in-plane direction, with the results shown in FIG. 4. Because electrical conductivity is also a function of the carbon fiber volume fraction, the carbon fiber volume fraction is also shown in FIG. 4. The through-thickness electrical conductivity of the test panels was approximately 1-2 S/cm, which is almost one order higher than the through-thickness electrical conductivity of the reference panel. Similarly, the in-plane electrical conductivity of the test panels was about three-to-four times greater than that of the reference panel. Although the electrical conductivity of CFRP panels can be increased by adding electrically conductive fillers into the matrix, this comes with a cost, namely a degradation in mechanical properties. The test panels, by contrast, possessed high electrical conductivity with no associated decrease in mechanical properties.

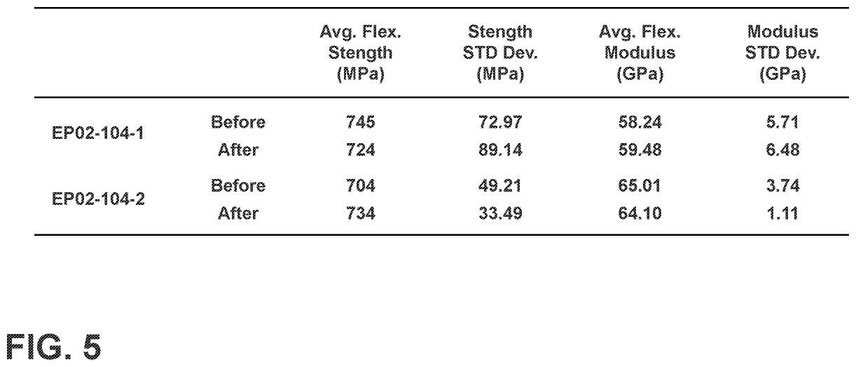

A visual inspection of the test panels after the simulated lightning strikes confirmed the absence of fiber breakage, resin evaporation, and delamination. Small discoloration and some fiber fuzziness around the lightning attachment location (center of the panel) was observed. This resilience to lightning strike damage can be attributed to the inherently high electrical conductivity of carbonized textile-grade PAN-based composites as compared to traditional epoxy composites. In addition, mechanical testing was performed to evaluate the mechanical properties of the test panels after the lightning strike tests. Three samples from the lightning strike location (center) and three samples from the side corners were cut from the test panels for flexural testing. A three-point bending test was chosen to measure strength and modulus losses. As shown in FIG. 5, the flexural strength and the modulus of both of the test panels from damaged and undamaged locations was found to be the same (within standard deviation). No reduction in the mechanical properties of the test panels confirmed that composite panels formed of carbonized conducting polymer fibers maintained their structural integrity even after being struck with a 200 kA simulated lightning strike.

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

1. A method of manufacturing comprising:
laying up a plurality of fiber-reinforced plies onto a surface of a mold, the plurality of fiber-reinforced plies each including a plurality of electrically conductive carbon fibers;
wetting each of the plurality of fiber-reinforced plies with a resin; and
curing the resin to form at least part of a wind turbine blade, such that the plurality of electrically conductive carbon fibers provide structural integrity to the wind turbine blade.

2. The method of claim 1, wherein the plurality of electrically conductive carbon fibers include carbonized polyacrylonitrile fibers.

3. The method of claim 1, wherein each of the plurality of electrically conductive carbon fibers are coated with a polyacrylonitrile film.

4. The method of claim 1, wherein the plurality of electrically conductive carbon fibers include carbon nanotubes that are coated on polyacrylonitrile fibers.

5. The method of claim 1, wherein the plurality of electrically conductive carbon fibers include polyacrylonitrile fibers with a graphene coating.

6. The method of claim 1, wherein the plurality of electrically conductive carbon fibers include polyacrylonitrile fibers with a polyaniline coating.

7. The method of claim 1, further including applying a vacuum to the plurality of fiber-reinforced plies while wetting the plurality of fiber-reinforced plies with a resin.

8. The method of claim 1, wherein wetting each of the plurality of fiber-reinforced plies includes individually wetting each of the fiber-reinforced plies with a high-temperature resin when layered onto a prior one of the plurality of fiber-reinforced plies.

9. A wind turbine blade comprising:
an outer shell comprising a pressure-side section and a suction-side section of a wind turbine blade; and
a spar disposed within the outer shell, wherein the outer shell comprises a plurality of electrically conductive carbon fibers with a cured resin matrix.

10. The wind turbine blade of claim 9, wherein the plurality of electrically conductive carbon fibers include carbonized polyacrylonitrile fibers.

11. The wind turbine blade of claim 9, wherein the plurality of electrically conductive carbon fibers include carbon fibers that are coated with a polyacrylonitrile film.

12. The wind turbine blade of claim 9, wherein the plurality of electrically conductive carbon fibers include carbon nanotubes.

13. The wind turbine blade of claim 9, wherein the plurality of electrically conductive carbon fibers include a polyacrylonitrile fibers with a graphene coating.

14. The wind turbine blade of claim 9, wherein the plurality of electrically conductive carbon fibers include a polyacrylonitrile fibers with a polyaniline coating.

15. The wind turbine blade of claim 9, wherein the outer shell is free of an insulating paint.

16. A pre-form for a wind turbine blade, the preform comprising:
a plurality of fiber-reinforced plies each including a plurality of electrically conductive fibers within a resin matrix, wherein the plurality of electrically conductive fibers include carbonized polyacrylonitrile (PAN) fibers, carbon fibers that are coated with a PAN film, or carbon nanotubes that are coated on PAN fibers.

17. The pre-form of claim 16, wherein the electrically conductive fibers include PAN fibers, and wherein the PAN fibers including a polyaniline coating.

18. The pre-form of claim 16, wherein the electrically conductive fibers include PAN fibers, and wherein the PAN fibers including a graphene coating.
